(19) United States
(12) Patent Application Publication
(10) Pub. No.: US 2006/0237564 A1
(43) Pub. Date: Oct. 26, 2006

(54) Truss rod safety for irrigation spans

(76) Inventor: Thomas J. Korus, Lindsay, NE (US)

Correspondence Address: HOVEY WILLIAMS LLP, 2405 GRAND BLVD., SUITE 400, KANSAS CITY, MO, 64108, US

(21) Appl. No.: 11/094,858

(22) Filed: Mar. 31, 2005

(51) Int. Cl. B05B 3/00

(52) U.S. Cl. 239/729

(57) ABSTRACT

A compression safety for a span of an agricultural irrigation system detects changes in the condition of truss rods associated with the framework of the span. When one portion of the truss rod assembly goes slack relative to another, such condition is detected by the safety to shut down the entire system. In a preferred embodiment, the safety is mounted at one of the V-braces forming part of the truss framework below the water conduit of the span. Truss rods are connected to and extend in opposite directions from the V-brace, one of such rods supporting a switch of the safety and the other supporting the switch actuator of the safety. The actuator comprises a long tubular member that is supported intermediate its ends by a fulcrum mount at the apex of the V-brace so that the operating lever of the switch is actuated by the actuator when it rocks about the fulcrum in response to a predetermined level of tension changes in the two truss rods.

### TECHNICAL FIELD

The present invention relates to agricultural irrigation systems of the type wherein conduit spans are supported by mobile, self-propelled towers for advancing the spans through the field and, more particularly, to a safety mechanism for such systems that detects when one or more of the spans is subjected to untoward compression forces as a result of encountering an obstacle in the field or other adverse circumstance.

### BACKGROUND AND SUMMARY

The conduits of irrigation spans associated with conventional irrigation systems are typically under compressive loading between mobile towers of the system and are maintained in such condition by rigidifying framework forming a part of each span. If one or more of the self-driven towers encounters an adverse circumstance such as a major obstruction, one or more of the spans may be subjected to an untoward level of compression that can severely damage the equipment. Consequently, various safeties have heretofore been provided for detecting the onset of such a situation and for immediately shutting down the system to prevent catastrophic failure.

The present invention contemplates a safety that effectively monitors the tension in one or more truss rod assemblies of a span for the purpose of taking appropriate safety measures, such as shutting down the entire system, in the event that a sufficiently adverse condition is detected. Inasmuch as the truss rod assemblies help rigidify and maintain the conduit in compression during normal operation, such truss rod assemblies are themselves normally in tension. Thus, if a conduit is subjected to greater than normal compressive loading at some point in time, portions of the truss rod assemblies will slacken, which condition can be detected and used by the system to take appropriate action.

In one preferred form of the invention, the safety comprises an electrical switch mounted on one portion of the truss rod assembly and a switch actuator mounted on another portion of the assembly. When relative motion occurs between such two portions during slackening of the truss rod assembly, such motion causes the actuator to actuate the switch if the magnitude of the relative movement exceeds a predetermined amount. Activation of the switch can be used to send a signal to the system controller or to otherwise immediately disable drive motors associated with the driven ground wheels of the towers. In a particularly preferred embodiment, the switch and switch activator are mounted on two separate truss rods that interconnect at a common point of connection with other structure of the framework, e.g., at the apex of a V-brace of the framework. The actuator spans across the apex of the V-brace but is supported at that point by a fulcrum-like mount that enables the actuator to rock about the mount when the truss rods move relative to one another. Such rocking movement is used to manipulate an operating lever of the switch so as to correspondingly operate a control circuit of which the switch is a part. Preferably, the actuator is adjustable axially with respect to the fulcrum mount so as to adjust the length of the effective lever arms on opposite sides of the fulcrum mount. This has the effect of adjusting the sensitivity of the safety.

### BRIEF DESCRIPTION OF THE DRAWINGS

FIG. 1 is an isometric view on a reduced scale of a typical irrigation system with which a safety in accordance with the present invention may be employed;

FIG. 2 is an enlarged, fragmentary elevational view of one side of one of the spans of the system illustrating the manner in which a safety in accordance with the present invention may be installed;

FIG. 3 is an enlarged, fragmentary top plan view of the system showing opposite sides of the span and the manner in which a safety can be installed on each side;

FIG. 4 is an enlarged, fragmentary transverse cross-sectional view through the system showing the two safeties;

FIG. 5 is a further enlarged isometric view of one of the safeties and associated structure of the irrigation span;

FIG. 6 is a fragmentary, exploded isometric view of the safety illustrating certain mounting components thereof;

FIG. 7 is a side elevational view of the system similar to FIG. 2 and illustrating the condition of the safety during normal operation;

FIG. 8 is a side elevational view similar to FIG. 7 but illustrating one example of a slackened condition in one of the truss rods that triggers the switch of the safety; and

FIG. 9 is an elevational view similar to FIGS. 7 and 8 but showing how movement of another one of the truss rods associated with the safety can result in actuation of the safety switch.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

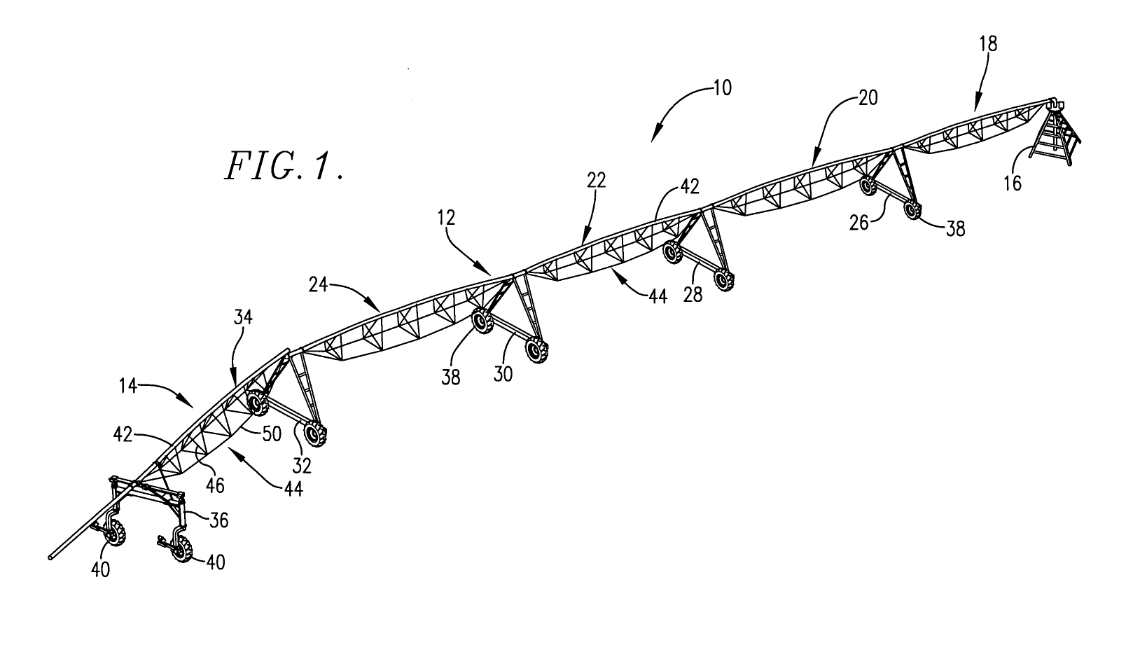

The irrigation system 10 selected for purposes of illustration in FIG. 1 comprises a center pivot system that includes a main section 12 and a corner section 14. Main section 12 is pivotally connected at its inner end to a stationary tower 16 having access to a well and is comprised of a number of interconnected spans 18, 20, 22 and 24 supported by mobile towers 26, 28, 30 and 32. Corner section 14 includes a single corner span 34 pivoted to the outer end of main section 12 at tower 32 and supported by its own steerable mobile tower 36. It will be appreciated that the safety of the present invention, as hereinafter described, may be utilized with any of the above noted spans, although it has particular utility in connection with corner span 34. Further, it will be recognized that the principles of the present invention are not limited to use with a center pivot system but may also be employed with other types of irrigation systems, including for example, lateral move systems and other types which do not employ a fixed center pivot tower.

As is well known, the non-steerable wheels 38 of main towers 26, 28, 30 and 32, and the steerable wheels 40 of steerable tower 36 are driven by suitable drive motors. As is also well known, steerable wheels 40 of tower 36 are pivoted about upright axes by a suitable steering motor associated with tower 36 so that tower 36 follows a predetermined track presented by a buried cable or the like. U.S. Pat. No. 4,508,269 in the name of Davis et al. is hereby incorporated by reference into the present specification for a disclosure of ground drive motors and steering motors associated with an irrigation machine. As is also well known, the drive motors for the towers are controlled by a suitable safety system such that they may be slowed or completely shut down in the event of the detection of an adverse circumstance, all of which is disclosed, for example, in U.S. Pat. No. 6,042,031 to Christensen, et al. incorporated herein by reference.

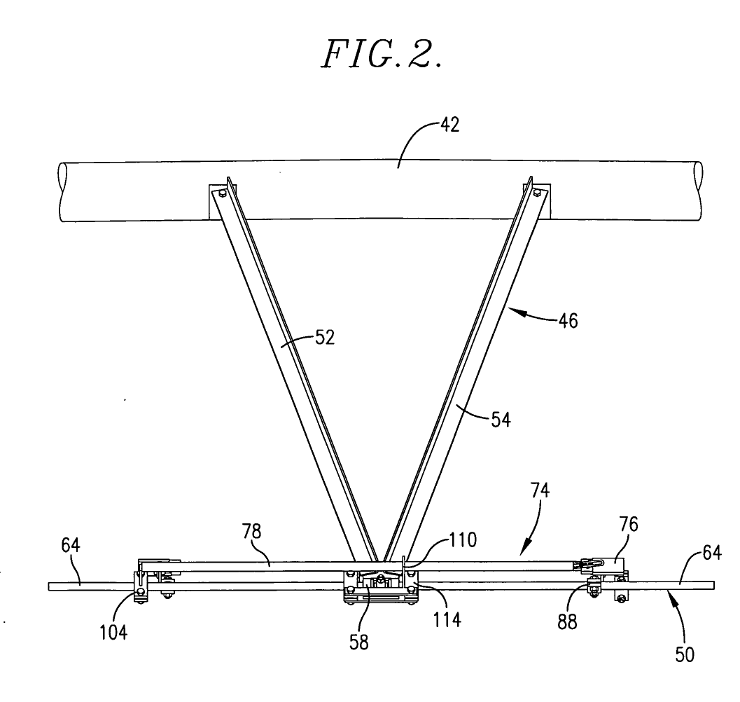

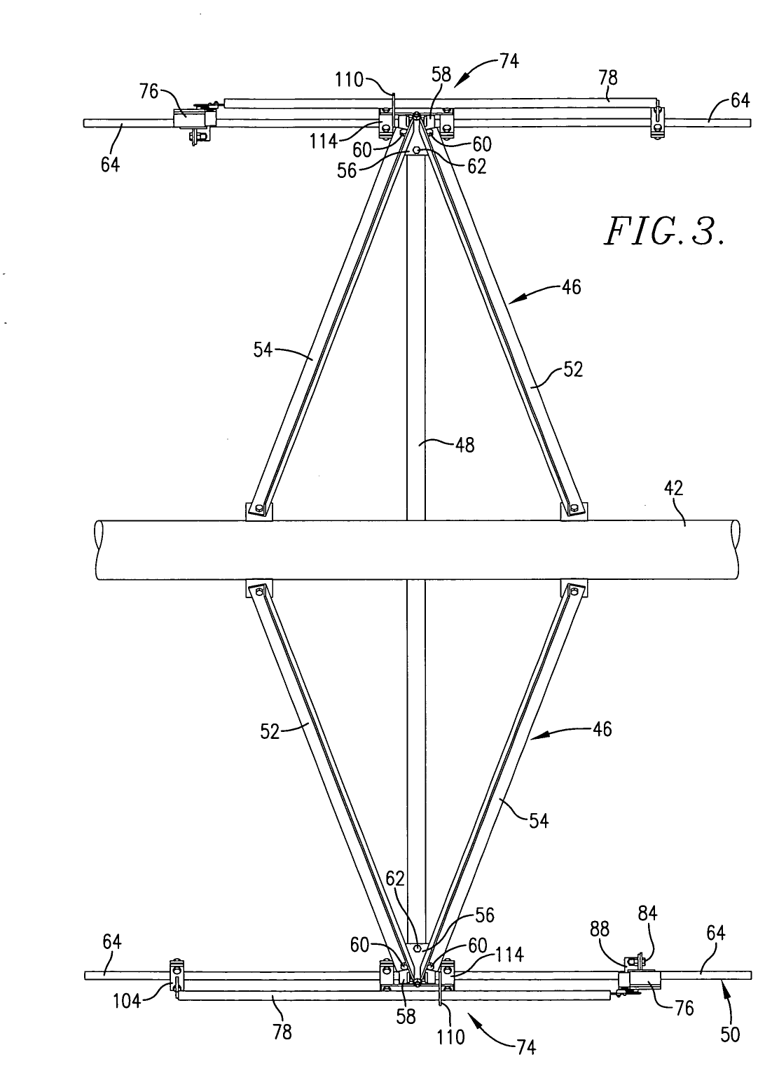

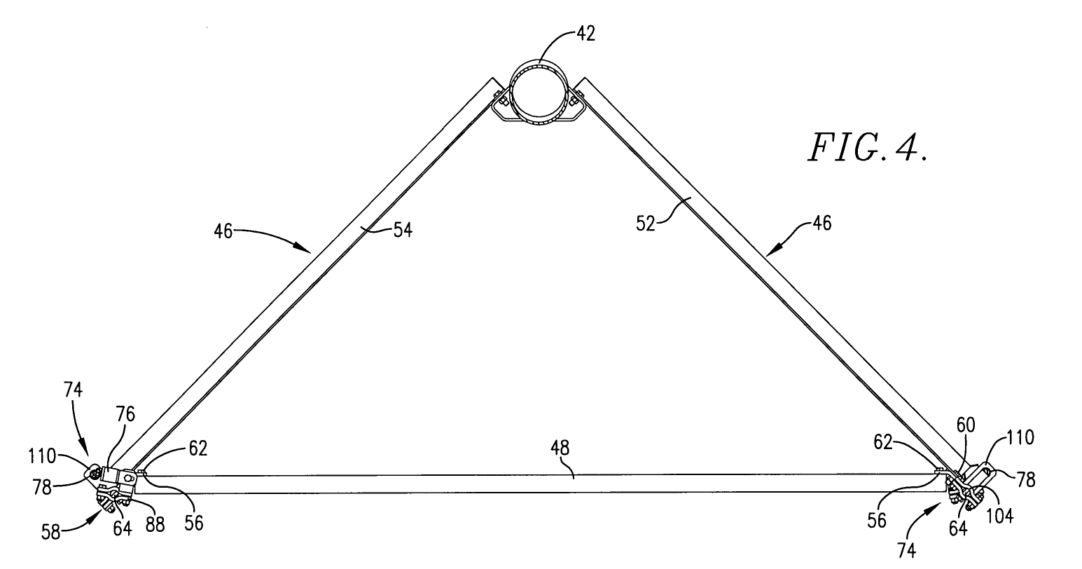

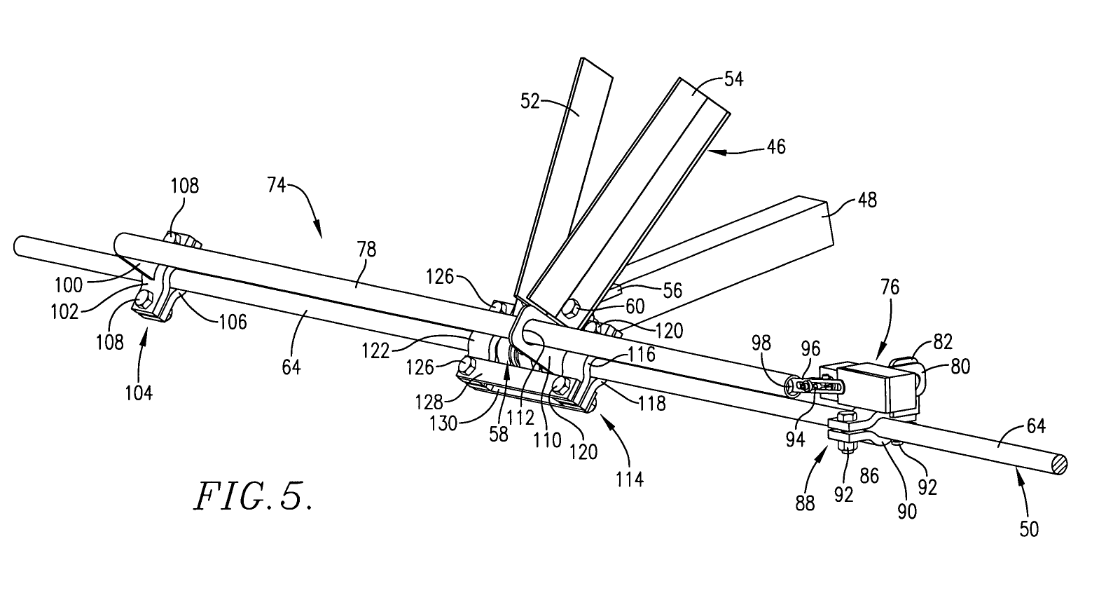

Each of the spans 18, 20, 22, 24 and 34 includes a conduit 42 that is connected in flow communication with all other conduits of the system to provide water along the length of the system to numerous sprinklers or other water emitting devices (not shown). Each conduit 42 is slightly arched or bowed when empty and is supported in such condition by a truss-type framework 44 connected to conduit 42 and disposed below the same. Among other things, each framework 44 includes a plurality of downwardly and outwardly angled V-braces 46 on one side of the conduit, as well as a horizontal, transverse brace 48 that interconnects opposing V-braces on opposite sides of conduit 42 at the apices of the V-braces. In addition, framework 44 includes a pair of truss rod assemblies 50 on opposite sides of conduit 42 that interconnect successive V-braces 46 at their apices and connect at opposite ends to terminal portions of the conduit 42. As illustrated in FIGS. 2-6, each of the V-braces 46 comprises a pair of rigid members 52 and 54 that are fixed at their upper ends to conduit 42 and converge at their lower ends to the top plate 56 of a coupling assembly 58. The lower and outer ends of members 52 and 54 are secured to plate 56 by bolts 60. Cross brace 48 is affixed to plate 56 at each coupling 58 by a bolt 62.

The truss rod assembly 50 on each side of framework 44 includes a series of individual truss rods 64 that are disposed generally in axial alignment with one another. Each truss rod 64 is connected to the next truss rod in the series at the apex of a V-brace 46, particularly at the coupling 58. Although not shown in detail, it is to be understood that the truss rods 64 that are connected at their opposite ends to V-braces 46 are provided with enlarged, cylindrical heads at their opposite ends that fit into and are securely held in pockets by corresponding couplings 58. In this respect, it will be noted that the top plate 56 of coupling 58 includes an upwardly humped portion 64 provided with a pair of side-by-side slots 66 and 68. A bottom plate 70 of coupling 58 is similarly configured and serves to cooperate with top plate 56 in clamping the headed ends of a pair of truss rods 64 into a securely retained condition at the apex of the V-brace 46. The opposing heads of each pair of successive rods 64 are received within the slots 66, 68, and a bolt 72 passes through plates 56, 70 to retain coupling 58 in a clamped condition.

In one preferred embodiment of the invention, the corner section 14 of the irrigation system 10 may be provided with a pair of safeties 74 on opposite sides of framework 44 for shutting down the entire system in the event corner section 14 encounters a sufficiently adverse condition such as a major obstacle in its path. Each safety 74 includes as its primary components a switch 76 and a switch actuator 78 for operating switch 76. Switch 76 comprises part of a safety circuit that is connected to the main control circuit of the system. In a preferred embodiment, switch 76 is normally closed so as to maintain the control circuit in full operation but can be actuated by actuator 78 to open the control circuit and shut down the entire system. Switch 76 is mounted on one portion of truss rod assembly 50 and actuator 78 is mounted on another portion of assembly 50.

In a preferred form of the invention, switch 76 is mounted on a truss rod 64 on one side of the apex of a V-brace, while actuator 78 is mounted on the next truss rod 64 on the other side of the V-brace apex. Switch 76 has a mounting tab 80 affixed to the backside thereof and projecting outwardly therefrom, which tab 80 is secured to an upstanding lug 82 by a bolt 84. Lug 82 is fixed to one-half 86 of a mounting clamp 88 that also includes a second half 90. Bolts 92 of clamp 88 securely tighten clamp 88 onto the truss rod 64. By loosening bolts 92, clamp 88 and thus switch 76 may be adjustably positioned in an axial direction along rod 64.

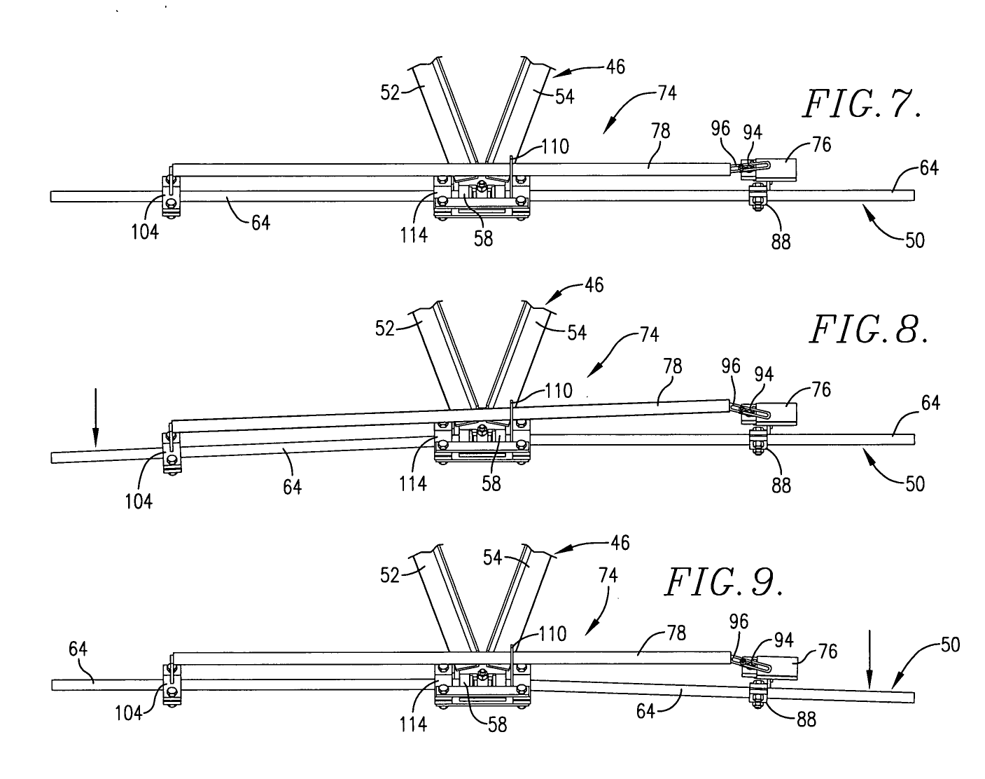

Switch 76 also includes a rotary shaft 94 that is rotatable between a closed position as in FIG. 7 and an open position as illustrated in FIGS. 8 and 9. Shaft 94 may be rotated approximately 10-15 degrees from the closed position before reaching its open position, at which time it opens the safety circuit with which switch 76 is associated. An operating arm 96 is fixed to shaft 94 and projects transversely therefrom to provide leverage for accomplishing rotation of shaft 94. Arm 96 may be adjusted with respect to shaft 94 to vary the extended length thereof beyond shaft 94. A roller 98 is secured to arm 96 at the end thereof that engages switch actuator 78 as discussed below. One satisfactory switch for performing the functions of switch 76 is available from Honeywell International Inc. as Microswitch part number LSA3K.

Switch actuator 78 preferably comprises a long tubular member having an open actuating end that receives roller 98 of switch arm 96 as illustrated at several places in the drawings. At its opposite end, actuator 78 is fixed to an upstanding mounting lug 100 that is fixed to the top half 102 of a mounting clamp 104. Upper half 102 of clamp 104 cooperates with a lower half 106 to securely attach actuator 78 to truss rod 64 on the opposite side of V-brace 46 from switch 76. Bolts 108 of clamp 104 serve to draw clamp halves 102,106 toward one another for securely gripping truss rod 64. Bolts 108 may be loosened as desired to permit axial adjustment of actuator 78 along the truss rod 64.

Actuator 78 is supported intermediate its opposite ends by a fulcrum support 110 at the apex of V-brace 46. Fulcrum support 110 is in the nature of a metal tab or ear having a hole 112 therethrough that loosely receives actuator 78. Thus, actuator 78 may rock about fulcrum support 110 as illustrated, for example, in FIGS. 7, 8 and 9. Furthermore, hole 112 permits actuator 78 to be adjustably shifted axially of truss rods 64 to adjust the length of the lever arm created by actuator 78 on opposite sides of fulcrum support 110. This effects the sensitivity of safety 74 inasmuch as having a short lever arm, for example, engaging switch roller 98 will normally make the safety less sensitive than having a long lever arm engaging the switch roller 98.

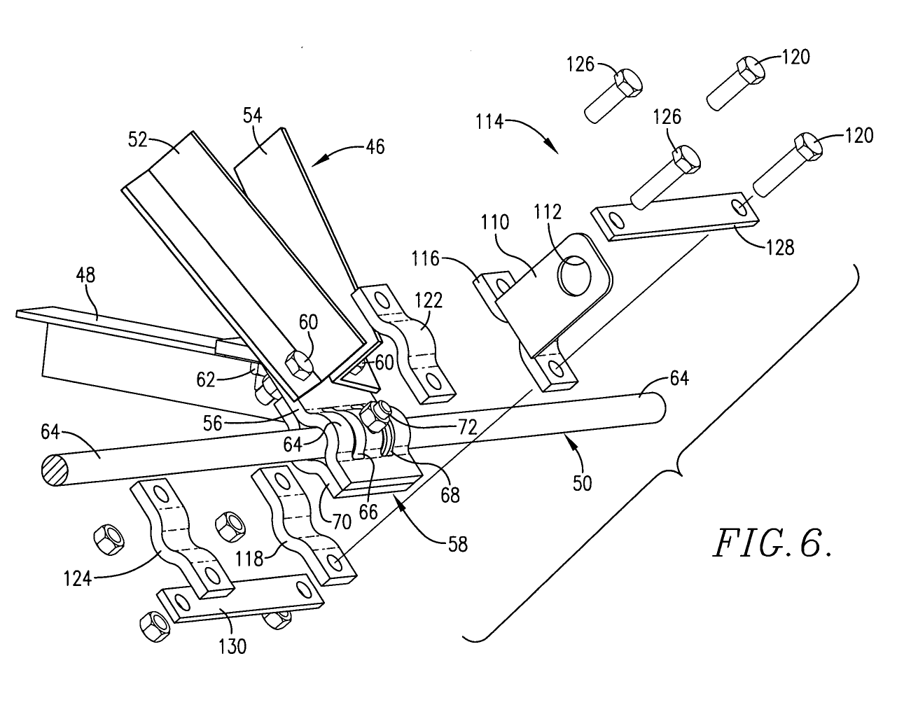

With particular reference to FIG. 6, it will be seen that fulcrum support 110 comprises part of a clamp assembly 114 that connects with the two truss rods 64 and with the coupling assembly 58. Trunnion support 110 is fixed to and projects upwardly from a top clamp half 116 that cooperates with a bottom clamp half 118 to attach fulcrum support 110 to the truss rod 64 on the switch side of V-brace 46. Bolts 120 draw clamp halves 116, 118 toward one another to securely grip truss rod 64. A second pair of top and bottom clamp halves 122 and 124 also comprise part of the clamp assembly 114 and are disposed on the truss rod 64 on the opposite side of V-brace 46 from switch 76. Bolts 126 draw clamp halves 122, 124 toward one another to securely grip truss rod 64 therebetween.

Clamp assembly 114 further includes a pair of upper and lower clamping bars 128 and 130 that extend generally parallel to truss rods 64 and interconnect clamp halves 116, 118 with clamp halves 122, 124. Clamping bars 128, 130 receive flat portions of coupling assembly 58 therebetween so that clamp assembly 114 is effectively attached to coupling assembly 58 by clamping bars 128, 130. This relationship prevents truss rods 64 from rotating about their longitudinal axes if and when they become slack, which rotation would cause the components of safety 74 to become improperly positioned with respect to one another and inhibit proper operation. Two of the bolts 120, 126 for clamp halves 116, 118 and 122, 124 also serve to secure clamp bars 128, 130 to clamp halves 116, 118 and 122, 124.

Operation

As noted above, in a preferred embodiment a pair of the safeties 74 are utilized on opposite sides of framework 44. The safety circuit is so arranged that in the event either of the safeties 74 is tripped, the entire irrigation system will shut down. However, the safety of the present invention is also beneficial if only one safety is utilized on one side of framework 44.

Furthermore, although the safety 74 will perform its role when stationed at a variety of different V-braces 46, it has been found to work best when positioned generally near the end of a span. Generally speaking, the truss rods 64 tend to go slack to a greater extent adjacent opposite ends of the span rather than in the middle when a span is subjected to untoward compression, thereby providing a better opportunity for sensing such adverse condition near the ends of the span than in the middle. When safety 74 is utilized with a corner section such as the section 14 in FIG. 1, it has been found that good results can be obtained when the safety 74 is located at the second or third V-brace from steerable tower 36. It will be appreciated that commercial forms of a corner section will normally include more V-braces than illustrated in connection with section 14 in FIG. 1.

The safety 74 is initially set up so that its various components are configured and arranged as illustrated in FIG. 7. Operating arm 96 of switch 76 is received within the open proximal end of actuator 78 and is in its closed position so that switch 76 completes the safety circuit.

If the left truss rod 64 viewing FIGS. 7-9, for example, goes slack as illustrated in FIG. 8, actuator tube 78 rocks in a counterclockwise direction lifting switch operating arm 96 by several degrees so as to correspondingly rotate switch shaft 94. If such rotation is greater than a predetermined amount, such as 10-15 degrees for example, switch 76 will open the safety circuit, causing the entire system 10 to shut down.

Correspondingly, if the right truss rod 64, viewing FIGS. 7-9 goes slack, switch 76 drops relative to actuator tube 78. If such movement is great enough, operating lever 96 will rotate switch shaft 94 sufficiently to open switch 76, thus opening the safety circuit and shutting down the entire system.

Obviously, in some instances, both truss rods 64 will go slack. This condition likewise causes the operating lever 96 to be rotated in a clockwise direction, and if such rotation is beyond the predetermined amount, switch 76 will open the safety circuit and cause the system to shut down.

It is important to note that safety 74 is easily reset following a condition that shuts down the entire system. In this respect, it will be noted that in most circumstances the operating arm 96 will remain received within the tubular open end of actuator 78 following shut down of the system. Consequently, there is no need to reconnect separated parts or members in order to re-establish the normal enabled condition of safety 74. Once the truss rods 64 are again fully tensioned, safety 74 will be returned to its normal enabled position of FIG. 7.

It will also be noted that safety 74 can be readily attached to existing irrigation systems already in the field without requiring major modifications. The major components of the safety can simply be bolted into place, along with the addition of a properly wired safety circuit.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. In an irrigation system having a liquid conduit spanning a pair of mobile towers and supported between the towers by framework that includes at least a pair of generally axially aligned truss rods connected to and extending in opposite directions from a common point of connection with other structure of the framework, the span normally being held in compression by the truss rods and the truss rods normally being in tension, a safety for detecting untoward compression in the conduit due to the application of an external force to the system comprising:
a switch on one of said truss rods; and
a switch actuator on the other of said truss rods and disposed for actuating said switch in response to relative movement between the truss rods.

2. In an irrigation system as claimed in claim 1,
said other structure of the framework including a generally V-shaped brace having a pair of members secured to said conduit at spaced locations along the length thereof and converging to an apex,
said point of connection of the truss rods with other structure of the framework being at said apex.

3. In an irrigation system as claimed in claim 2,
said framework further including a second generally V-shaped brace on a side of the conduit opposite from the first-mentioned brace,
said second brace having a pair of members secured to said conduit at spaced locations along the length thereof and converging to an apex,
said framework further including a second pair of truss rods connected to and extending in opposite directions from the apex of said second V-shaped brace and an elongated, transversely extending brace interconnecting said V-shaped braces at their apices.

4. In an irrigation system as claimed in claim 3,
further comprising a second switch on one of the truss rods of said second pair of truss rods and a second actuator for said second switch on the other truss rod of said second pair of truss rods.

5. In an irrigation system as claimed in claim 2,
said actuator being elongated and extending across said apex from said one truss rod to the other truss rod,
further comprising a fulcrum at said apex operably coupled with said actuator for permitting the actuator to rock about the fulcrum during relative movement of the truss rods.

6. In an irrigation system as claimed in claim 5,
said actuator being tubular, presenting an open end adjacent said switch,
said switch having an operating arm received within said open end of the actuator.

7. In an irrigation system as claimed in claim 5,
said actuator being axially adjustably secured to said other truss rod for adjusting the effective location of said fulcrum with respect to opposite ends of the actuator.

8. In an irrigation system as claimed in claim 7,
said fulcrum having a hole loosely receiving said actuator.

9. In an irrigation system as claimed in claim 1,
said actuator being elongated and extending across said common point of connection from said one truss rod to the other truss rod,
further comprising a fulcrum at said common point of connection operably coupled with said actuator for permitting the actuator to rock about the fulcrum during relative movement of the truss rods.

10. In an irrigation system as claimed in claim 9,
said actuator being axially adjustably secured to said other truss rod for adjusting the effective location of said fulcrum with respect to opposite ends of the actuator.

11. In an irrigation system as claimed in claim 10,
said fulcrum having a hole loosely receiving said actuator.

12. In an irrigation system as claimed in claim 1,
further comprising a support for said actuator at said common point of connection of the truss rods with other structure of the framework.

13. In an irrigation system as claimed in claim 12,
said support having a hole loosely receiving said actuator.

14. In an irrigation system as claimed in claim 1,
said actuator comprising an elongated tubular member,
said switch having a operating arm received within a proximal end of the tubular member.

15. In an irrigation system as claimed in claim 1,
said system comprising a center pivot system.

16. In an irrigation system as claimed in claim 15,
said conduit comprising part of a corner pivot span of the center pivot system.

17. In an irrigation system having a liquid conduit spanning a pair of mobile towers and supported between the towers by framework that includes an elongated truss rod assembly, a safety for detecting untoward compression in the conduit comprising:
a switch on one portion of said truss rod assembly; and
a switch actuator on another portion of said truss rod assembly spaced longitudinally from said one portion,
said actuator being disposed for actuating said switch in response to relative movement between said portions of the truss rod assembly.

18. In an irrigation system as claimed in claim 17,
said actuator comprising an elongated, rigid member,
further comprising a support for said member disposed intermediate a pair of opposite ends thereof.

19. In an irrigation system as claimed in claim 18,
said support being mounted on a part of said framework other than said truss rod assembly.

20. In an irrigation system as claimed in claim 18,
said support permitting the member to rock about the support during relative movement between said portions of the truss rod assembly.

21. In an irrigation system as claimed in claim 20,
said support having a hole loosely receiving said member.

22. In an irrigation system as claimed in claim 17,
said actuator comprising an elongated, rigid tube.

23. In an irrigation system as claimed in claim 21,
said switch having an operating lever projecting into a proximal end of said tube.

24. In an irrigation system as claimed in claim 17,
said truss rod assembly including at least a pair of generally axially aligned truss rods connected to and extending in opposite directions from a common point of connection with other structure of the framework.

25. In an irrigation system as claimed in claim 17,
said system comprising a center pivot system.

26. In an irrigation system as claimed in claim 25,
said conduit comprising part of a corner pivot span of the center pivot system.
